(19) United States
(12) Patent Application Publication
(10) Pub. No.: US 2006/0255795 A1
(43) Pub. Date: Nov. 16, 2006

(54) Six-degree-of-freedom, integrated-coil AC magnetic tracker

(76) Inventors: Robert F. Higgins, Richmond, VT (US); Allan G. Rodgers, Jericho, VT (US); Donald M. Dickinson, Ridgecrest, CA (US)

Correspondence Address: John G. Posa;Gifford, Krass, Groh, Sprinkle,, Anderson & Citkowski, P.C., PO Box 7021, Troy, MI, 48007-7021, US

(21) Appl. No.: 11/431,470

(22) Filed: May 10, 2006

Related U.S. Application Data
(60) Provisional application No. 60/680,871, filed on May 13, 2005.

(51) Int. Cl. G01B 7/30

(52) U.S. Cl. 324/207.17

(57) ABSTRACT

The 3-axis field source coils and 3-axis sensor coils derived from off-the-shelf suppliers in a magnetic tracker are integrated with driving and sensing circuitry to provide a complete six-degree-of-freedom tracker in only two modules: a sensor module and a source module plus being able also to track with at least a second sensor of identical design. One or both of the basic tracker modules may be mounted on respective single printed-circuit boards, and the source module may take advantage of digital wave generation and tuned coil drivers for reduced hardware. One or both of the coil sets may be non-concentric, and the output for providing P&O updates to a host computer may take advantage of a connector that receives electrical power from the host computer, such as a USB/USB-2 connector. To further reduce system cost, the circuitry used to amplify the signals received by the sensor coils may be multiplexed under control of the processor on the source board.

### REFERENCE TO RELATED APPLICATION

This application claims priority from U.S. Provisional Patent Application Ser. No. 60/680,871, filed May 13, 2005, the entire content of which is incorporated herein by reference.

### FIELD OF THE INVENTION

This invention relates generally to magnetic trackers and, in particular, to a two-module tracker providing economical yet accurate results.

### BACKGROUND OF THE INVENTION

In a classical AC magnetic tracking system there typically are four basic components: a 3-axis field source (source), a 3-axis field sensor (sensor), a system electronics unit (SEU) and a power supply. FIG. 1 shows a typical AC magnetic tracker where three orthogonal coils (1) are driven to provide magnetic fields that couple to similar 3-axis orthogonal coils (2) all being managed, driven (4) and sensed (6) by a programmable system electronics unit (SEU) that performs calculations to present the relative position and orientation (P&O) between the source and sensor.

The source creates 3-dimensional AC magnetic dipole fields when driven by the SEU. These fields couple to the sensor, whose signal is amplified and synchronously sampled and adapted with known characterization files by the SEU to produce a signal matrix for computing position and orientation (P&O) of the relative location between source and sensor. The P&O result is provided to a host computer over a high speed bus to be used in any one of a growing multitude of 3D applications. The power module of course provides the required DC bias voltages to operate the tracker. This is then a typical single sensor AC magnetic tracker system.

One of the major impediments to widespread tracker use is the size of the system for ready integration into consumer items. Another drawback is the high cost compared to the relatively low cost of such items as electronic games and even personal computers. Purchase price is generally a few thousand US dollars. Affordable trackers that have become available up to this time typically utilize an inferior technological approach such as a tilt sensor, which is prone to great error in a dynamic setting since it cannot distinguish other accelerations from the acceleration due to gravity. Indeed there appears to be a size, price and performance barrier to the wider acceptance of 3D consumer tracker systems.

One of the size/cost drivers is the orthogonal 3-axis coils themselves, which up to this time have been constructed using special equipments and proprietary processes. Another cost driver is the complete separation of different functions into at least three units that require special custom cabling to achieve acceptable results. Another is the design and construction of special circuit boards and their housing. Still another typical requirement is a power source capable of many watts of power and usually multiple DC bias voltages. Hence, a need for a higher level of integration, much better efficiency, speedy and flexible processing and lower cost components all taken together simultaneously is a challenge that would be a valuable advance to making six degree-of-freedom tracking widely available.

### SUMMARY OF THE INVENTION

This invention improves upon existing AC magnetic trackers by integrating 3-axis field source coils and 3-axis sensor coils with driving and sensing circuitry to provide a complete six-degree-of-freedom tracker in only two modules: a sensor module and a source module.

In the preferred embodiment, the sensor module includes a set of sensor coils and circuitry to amplify signals received by the sensor coils. The source module includes a set of source coils and coil drivers, an input for receiving the amplified signals from the sensor module, a processor for computing the position and orientation (P&O) of the sensor module based upon the signals received, and an output for providing P&O updates to a host computer. A cable is used to interconnect the two modules for delivery of the amplified sensor signals to the processor for the P&O computations. By virtue of the circuitry used to amplify the signals received by the sensor coils, the interconnecting cable can be an economical component with standard connectors.

One or both of the modules may be mounted on respective single printed-circuit boards, and the source module may be integrated with the processing electronics to take advantage of being in a single module and simple +5 VDC tuned coil drivers for reduced hardware. One or both of the coil sets may be non-concentric, and the output for providing P&O updates to a host computer may take advantage of a connector that receives electrical power from the host computer, such as a USB/USB-2 connector. To further reduce system cost, the circuitry used to amplify the signals received by the sensor coils may be multiplexed under control of the processor on the source board.

### BRIEF DESCRIPTION OF THE DRAWINGS

FIG. 1 is a simplified block diagram of a prior-art AC magnetic tracker;

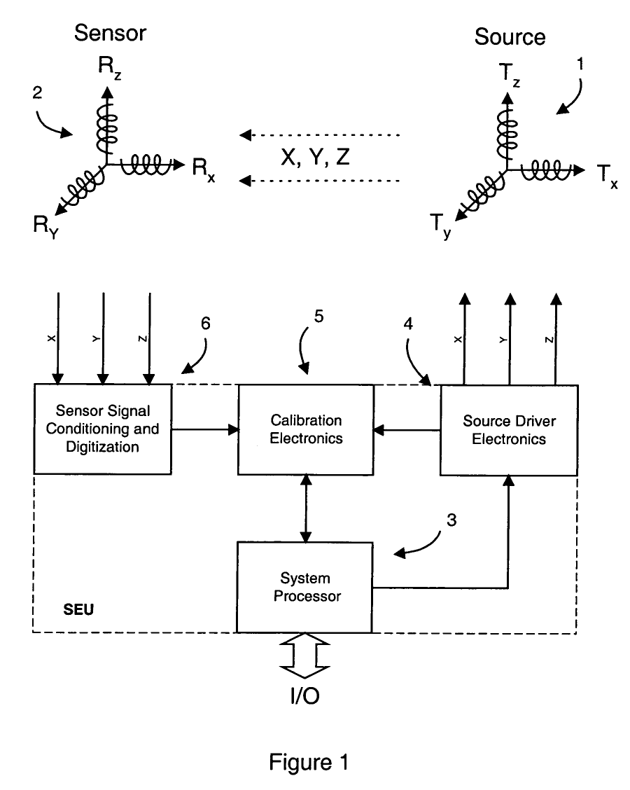

FIG. 2 is a simplified block diagram of an AC magnetic tracker system partitioned in accordance with this invention;

FIG. 3 is a drawing that shows how orthogonal mountings may be positioned on a small printed circuit board; and

FIG. 4 is a simplified block diagram of an AC magnetic tracker system with multiplexed sensor coils.

### DETAILED DESCRIPTION OF THE INVENTION

In order to reduce the size and cost of a six degree-of-freedom AC magnetic tracker several factors must be addressed simultaneously. As mentioned above, winding 3-axis coils on orthogonal axes concentrically for high performance trackers has not yet become a high-volume process. As a consequence, this still requires much manual intervention and many proprietary processes. Other proprietary processes are used to achieve the best possible calibration and uniformity in performance.

Although many coils are mass-produced in the electronics industry today through automated, high-speed techniques for communication circuits, power supplies, signal filters and many other applications. Use of three of these arranged in an orthogonal, non-concentric mechanization would go far to reduce cost and possibly also size. However, issues remain, including: 1) adequate effective area for obtaining sufficient signals; 2) mounting on multiple faces without extensive mechanical fixturing (which would nullify the cost savings); and 3) self-resonance frequencies well above those used in the tracker. A hidden factor is the non-concentricity of such coils for computing location, but commonly owned U.S. Pat. No. 5,307,072 teaches mathematical solutions to non-concentricity.

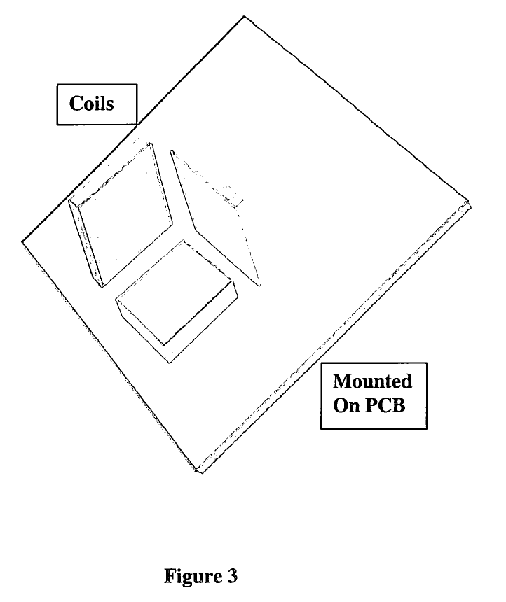

As shown in FIG. 3, coils may be positioned on a small printed circuit board (PCB) to make orthogonal mountings without being concentric. A cable could be attached to this small PCB, but the low level of the signals would require very special cabling such as shielded twisted pair conductors. Thus, according to this invention, small low-noise preamplifier circuits are mounted on the PCB to boost the signals, allowing a more generic multi-conductor cable to be used. Further savings may be realized if a standard connector is mounted to the PCB allowing use of a readily available, pre-terminated everyday cable. Although cables such as those used in the telephone industry have parallel rather than twisted wires with electronic shielding, the right combination of coils, amplifiers and line-driving allows all of these goals and requirements to be met.

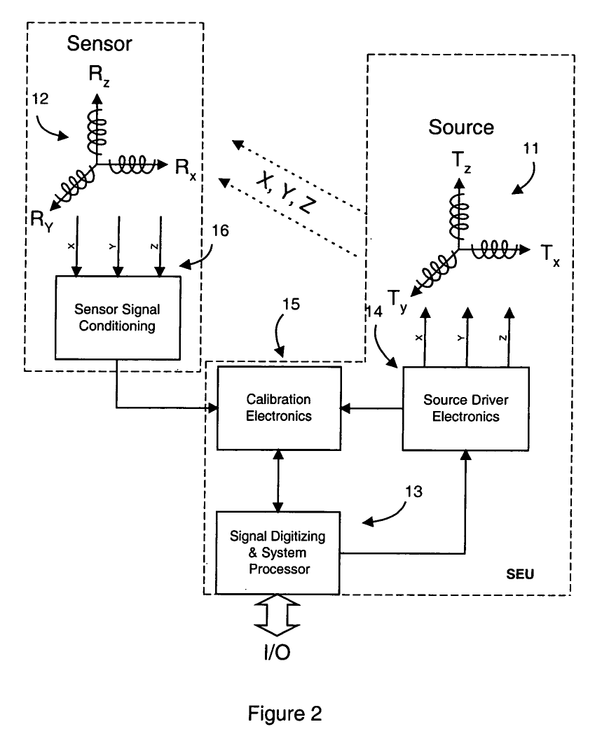

Using this approach, a design partition at the amplifier output is possible, as shown in FIG. 2. To ensure this approach is dependable, experiments have been conducted which confirm that a converging characterization process and acceptable P&O results are possible with non-concentric coils plus circuitry and a commercially available connector, all in the same proximity. There will be a limit to the length of the cable, but operation to over several feet has already been demonstrated as feasible.

The remaining circuit block (“SEU” in FIG. 2) must provide the AC magnetic field signals, sensor signal processing, system control, P&O computation and output to a host computer to provide updates at a rate of at least 60 Hz. Larger commercial coils mounted in a manner similar to the sensor coils of FIG. 3 can be procured. However, the required circuitry for driving the source coils and performing all the control and processing operations is many times larger than the small amplifiers with the sensor coils. Much of the burden for minimizing circuitry falls on the microprocessor used and its ability to execute the embedded code rapidly enough to satisfy all these requirements.

Key among the source module requirements is the electronics for creating the sine waves to drive the coil axes. The input for creating the sine waves needed for the coil drive can be either stored in tables or generated dynamically using embedded code. Either way, digital samples are presented to a digital-to-analog converter (DAC) and then to drive circuits and then into the tuned circuit of the coil. The tuned circuit improves efficiency and smooths the small digital steps created from the digital inputs.

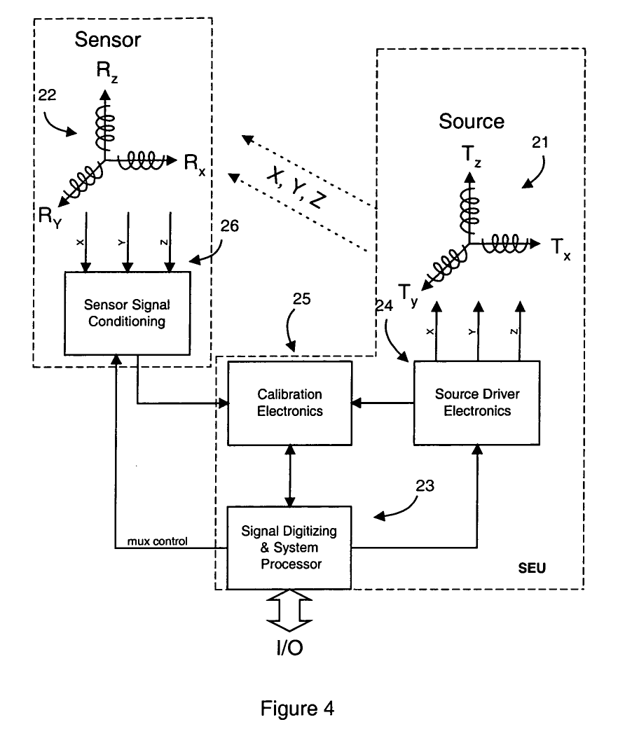

Circuitry for digitizing and processing sensor signals also relies heavily on the microprocessor. Again, this circuitry can be minimized if a single channel can be time shared among the three sensor coils at the sensor module. It is possible according to the invention to insert an analog multiplexer in front of a single preamp/line driver at the sensor and still keep the sensor small and simple, with switching carried out by the microprocessor (FIG. 4). Although the microprocessor must provide all system synchronization, multiplexing of a single sensor preamp is easily handled.

There is an added advantage of time-sharing the sensor amplifier besides circuitry savings, namely, by passing all three coil signals through the same gain channel, the drift of one channel relative to another is then of no concern. Only a slight change in the sensor range would occur if the single channel were to drift. Orientation is unaffected by this so that if a slight variation in range is tolerable, dynamic calibration of the sensor becomes unnecessary.

If the source coils are to reside successfully with the microprocessor and other circuitry, this assemblage also must be capable of a converging characterization process with acceptable P&O performance. Small size and minimal use of power and ground planes are critical to achieving this performance.

The only remaining issues to be discussed concern output of P&O data to a host computer and obtaining power, which often in the past has necessitated an additional module. These two problems are solved with a single solution. The standard USB (Universal Serial Bus) connection with a personal computer can provide not only a high data rate but also one-half ampere of current at five volts DC. By taking advantage of the push in the semiconductor industry for smaller and lower power circuitry, the complete tracker described herein can be powered by the 2.5 watts available from a standard USB connection, thereby eliminating the need for any additional tracker modules.

Further, the approach for source coil drive though a DAC into a simple driver operated from +5 VDC USB power is sufficient for this design without the typical high-voltage bipolar drives of past AC magnetic trackers so that simplicity and efficiency are conserved. Thus, the I/O bus of FIG. 2 is implemented with a standard USB connection, which also means very little space is consumed by connectors (sensor and I/O only, unless one's application must remote the source coils), and inexpensive standard cabling to the host computer also is readily available.

In summary, this invention is effective in reducing both the size and cost of a simple source-sensor AC magnetic tracker. Size reduction is achieved through circuitry simplification and a high degree of system integration such as including the magnetic field source with the electronics. High performance, low-power semiconductors allow power to be provided by the host PC. Cost reduction is achieved largely through the use of readily available commercial coil forms and utilizing our pre-existing con-concentric coil patent. Application-specific integrated circuits (ASICs) may further reduce size and cost.

We claim:

1. An AC magnetic tracking system, comprising:
a sensor module including:
at least one set of sensor coils,
circuitry to amplify signals received by the sensor coils;
a source module including:
a set of source coils and coil drivers,
an input for receiving the amplified signals from the sensor module,
a processor for computing the position and orientation (P&O) of the sensor module based upon the signals received, and
an output for providing P&O updates to a host computer; and
a cable interconnecting the two modules for delivery of the amplified sensor signals to the processor for the P&O computations.

2. The AC magnetic tracking system of claim 1, wherein the cable is interfaced to one or both of the modules through a connector.

3. The AC magnetic tracking system of claim 1, wherein the source module uses digital wave generation and tuned coil drivers.

4. The AC magnetic tracking system of claim 1, wherein one or both of the modules are each mounted on a single printed-circuit board.

5. The AC magnetic tracking system of claim 1, wherein one or both of the coil sets are non-concentric.

6. The AC magnetic tracking system of claim 1, wherein the output for providing P&O updates to a host computer uses a connection that receives electrical power from the host computer.

7. The AC magnetic tracking system of claim 1, wherein the circuitry to amplify signals received by the sensor coils is multiplexed on a per-coil basis under control of the processor in the source module.

8. An AC magnetic tracking system, comprising:
a sensor module including a set of sensor coils,
a source module including:
a set of source coils and coil drivers,
an input for receiving signals from the sensor module,
a processor for computing the position and orientation (P&O) of the sensor module based upon the signals received, and
an output for providing P&O updates to a host computer; and
wherein the source module uses digital wave generation and tuned coil drivers.

9. The AC magnetic tracking system of claim 8, wherein one or both of the modules are each mounted on a single printed-circuit board.

10. The AC magnetic tracking system of claim 8, wherein one or both of the coil sets are non-concentric.

11. The AC magnetic tracking system of claim 8, wherein the circuitry to amplify signals received by the sensor coils is multiplexed on a per-coil basis under control of the processor in the source module.

12. An AC magnetic tracking system, comprising:
a sensor module including a set of sensor coils,
a source module including:
a set of source coils and coil drivers,
an input for receiving signals from the sensor module,
a processor for computing the position and orientation (P&O) of the sensor module based upon the signals received, and
an output for providing P&O updates to a host computer; and
wherein the output uses a connector that receives electrical power from the host computer.

13. The AC magnetic tracking system of claim 12, wherein the cable is interfaced to one or both of the modules through a connector.

14. The AC magnetic tracking system of claim 12, wherein the source module uses digital wave generation and tuned coil drivers.

15. The AC magnetic tracking system of claim 12, wherein one or both of the modules are each mounted on a single printed-circuit board.

16. The AC magnetic tracking system of claim 12, wherein one or both of the coil sets are non-concentric.

17. The AC magnetic tracking system of claim 12, wherein the circuitry to amplify signals received by the sensor coils is multiplexed on a per-coil basis under control of the processor in the source module.

18. The AC magnetic tracking system of claim 12, wherein the processor is operative process at least two sensor outputs and control sensor preamplifiers using the same multiplexing signals that would be sent to a single sensor.
